(19) United States
(12) Patent Application Publication
(10) Pub. No.: US 2002/0140203 A1
(43) Pub. Date: Oct. 3, 2002

(54) Mini bike folding mechanism

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/820,630

(22) Filed: Mar. 30, 2001

(51) Int. Cl. B62K 1/00

(52) U.S. Cl. 280/287

(57) ABSTRACT

A folding mechanism for mini bike, comprised of a head tube, a pivoted inner tube, two tube retainers, one lower section of stem, a joint, and an upper section of stem. Wherein, a section provided with a slit protrudes from the pivoted inner tube inside the head tube for a proper length to be inserted to a tube retainer whereupon a fixing bolt extending into said slit. The joint provided at the lower end of the lower section of the stem allows the lower section of the stem to penetrate and connect to the pivoted inner tube. The joint is comprised of an upper section and a lower section pivoted to each other with a local part of the lower section of the joint regularly extending into the pivoted inner tube in position. Another tube retainer is provided to connect the upper end of the lower section of the stem so to pass through the tube retainer and insert into the lower section of the stem.

### BACKGROUND OF THE INVENTION

(a) Field of the Invention

The present invention relates a mechanism to fold up a mini bike for storage, and more particularly to one that allows the handle of the bike to be extended by section and folded up for storage while a pivot structure so folded retreats into a head tube when the bike is in use while at where extended and folded can be fixed in position with adapted retainer having a fast wrench.

(b) Description of the Prior Art

Whereas there are many types of bicycles generally available in the market, and this Inventor has invested a lot of efforts in the R&D for innovative improvement of the production of the bicycles for the benefits of the consumer. Now, in this invention, this Inventor by pushing aside the traditional design concept for a bicycle focuses on a mini bike that provides more fun and more strict context of leisure activity in attempting a planned improvement for the type of said mini bike. In addition to having smaller frame than the general bicycle, the mini bike also requires smaller wheels. Therefore, the body of the mini bike not only appears to be lower due to the reduced frame and wheels, but the length between the front and the rear frame is shorter. Furthermore, the mini bike is not designed for children to ride, and its design permits the riding by teenagers. This requires the reduced frame must fall wherein the specifications that allow the grownup to ride. With nothing changed to the height of an average grownup, the reduced body of the bike both in height and length would require longer stem to promote the height of the body of the bike while the handle may be slightly extending forward to meet ergonomics for an easy and comfort riding by the grownup.

However, once the height of the body of the bike is elevated due to the longer stem, tubes adapted to the handle of the bike could become excessively long to prevent easier carriage of the bike and reduced saving space disregarding that the overall frame may be shorter. Therefore, a retractable and foldable mechanism adapted to the mini bike is the best solution.

Accordingly, a retractable and foldable mechanism is planned in the present invention at the extra length of the handle where proves to consume most space consuming.

### SUMMARY OF THE INVENTION

The primary purpose of the present invention is to provide a folding mechanism for a mini bike by allowing a stem to be extended by section and folded up for storage. The pivoted portion at where the folding takes place retreats into a head tube of the bike when in use and at an extension end and where the folding occurs are respectively fixed in place using a retainer having a fast wrench. As a result, the stem is shortened for easy storage and carriage. The present invention is essentially comprised of a section in proper length extending upward from a pivoted inner tube inside a head tube and connecting to a stem. Wherein, a slit is provided axially on the wall of said extended section and a retainer having a fast wrench is adapted to the extended section. A fixing bolt is provided on the retainer and extends into the slit of said extended section. The stem is divided into an upper section and a lower section. The lower part of the latter is inserted into the pivoted inner tube with a joint provided at an end of the insertion. The joint is comprised of an upper part and a lower part pivoted to each other. A longitudinal slide at one side of the joint corresponding to the fixing bolt while a portion of the lower part the joint extends into the pivoted inner tube in position in normal condition. Tenon and recess are provided at the meeting inner ends of both of the upper part and the lower part of the joint. Furthermore, the upper end of the lower section of the stem is each provided axially on its both symmetrical sides a slit and a hole to engage a retainer having a fast wrench. The retainer is coupled to the fixing bolt with a threaded hole provided at where corresponding to the hole. The upper section of the stem fixed to the body of the bike is inserted through the retainer and connected to the lower section of the stem whereby the upper section of the stem can be extended and fixed in place relatively to the lower section of the stem. The entire handle adapted to the stem can be folded by pulling out the upper part of the joint of the lower section of the stem upon releasing the retainer on the pivoted inner tube.

### BRIEF DESCRIPTION OF THE DRAWINGS

FIG. 1 is a schematic view with an exploded view of the present invention.

FIG. 2 is a schematic view showing the present invention adapted to a body of a mini bike.

FIG. 3 is a sectional view of an assembly of the present invention.

FIG. 4 is a schematic view showing a shortened handle in the present invention.

FIG. 5 is a schematic view showing how the present invention is folded up.

FIG. 6 is another schematic view showing how the present invention is folded up.

FIG. 7 is a schematic view showing the present invention when folded up.

FIG. 8 is a schematic view showing changes in the handle in the present invention.

FIG. 9 is a schematic view showing another preferred embodiment of the present invention.

FIG. 10 is a sectional view of another preferred embodiment of the present invention.

### DETAILED DESCRIPTION OF THE PREFERRED EMBODIMENTS

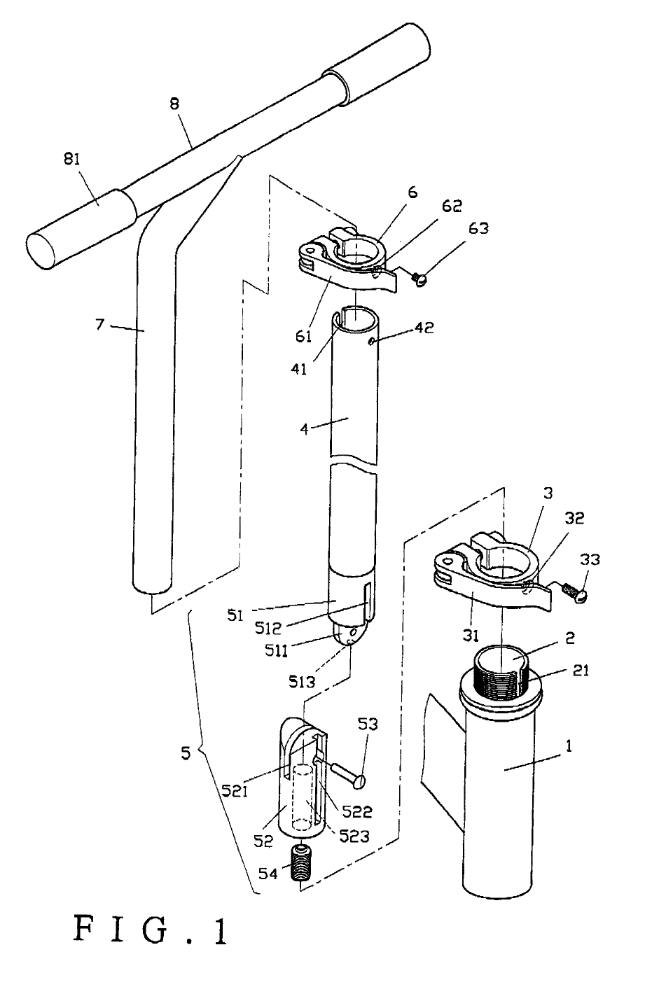

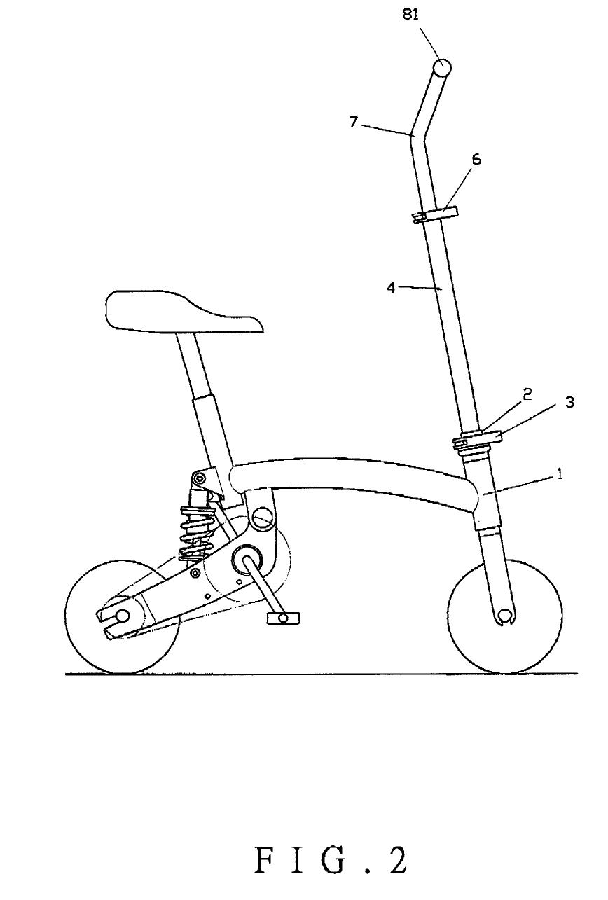

Referring to FIGS. 1 and 2, a preferred embodiment of the present invention includes a head tube (1), a pivoted inner tube (2), two retainers (3) and (6), a lower section of a stem (4), a joint (5), an upper section of the stem (7) and a handle (8). Wherein, a section in proper length protrudes upwardly from the pivoted inner tube (2) in the head tube (1). A slit (21) is provided axially on the wall of the protruded section and an end of the protruded section is engaged to a retainer (3) with a fast wrench (31). A threaded hole (32) is provided on a ring of the retainer (3) to couple a fixing bolt (33) to extend into the slit (21) in the pivoted inner tube (2).

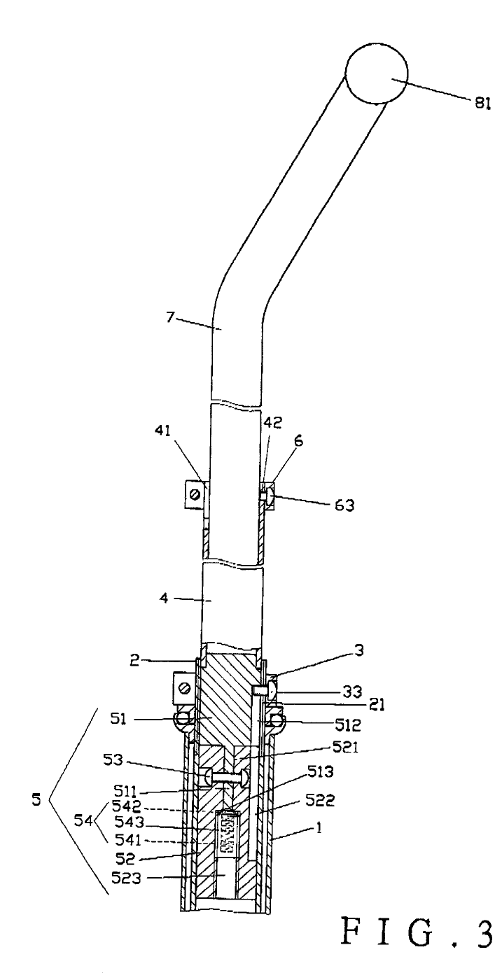

A joint (5) is provided at the lower end of the lower section of the stem (4) and inserted into the pivoted inner tube (2). Said joint (5) is comprised of an upper part (51) and a lower part (52) pivoted to each other. Both said upper part (51) a lower part (52) are mutually inserted into a pivot (521) using a protrusion plate (511). A rivet (53) is used to pass through to connect both of the upper part (51) and the lower part (52). Two recessed longitudinal slides (512) and (522) formed respectively on both outer sides of the upper part (51) and the lower part (52) facing in the direction of the slit (21) of the pivoted inner tube (2) for receiving the fixing bolt from the retainer (3) extend and hold against the matching recessed slide (512) and (522). Meanwhile the lower part (52) of the joint (5) in normal condition extends into the pivoted inner tube in position. A hole (523) is provided wherein either relative inner end of the upper part (51) or the lower part (52) of the joint (5) (as illustrated, the lower part (52)) to accommodate a tenon (54). The tenon (54) is comprised of a coil (541) holding against a steel ball (542) and a chamber (543) containing said coil (541) and steel ball (542) as illustrated in FIG 3. The protruded plate (511) on the upper part (511) is provided with a recess (513) at where corresponding to the steel ball (542) of the tenon (54). Furthermore, a slit (41) together with a hole (42) is each provided axially on both symmetrical sides of the upper end of the lower section of the stem (4) to insert into another retainer (6) having a fast wrench (61). A threaded hole (62) is provided on the retainer (6) relatively to the hole (42) in the lower section of the stem (4) to couple a fixing bolt (63). The upper section of the stem (7) passes through the retainer (6) and is inserted into the lower section of the stem (4). The upper portion of the upper section of the stem (7) extends forwardly and upwardly at a certain inclination to be fixed to a lateral section of the body of the handle (8) with handles (81) respectively provided to both ends of the lateral section.

Now, referring to FIG. 3, the section protruding upward from the pivoted inner tube (2) is inserted into the retainer (3) having a fast wrench so to accommodate inside the pivoted inner tube (2) with the joint (5) connected to the lower end of the lower section of the stem (4). The position bolt (33) of the retainer (3) worms into the slit (21) and holds against both recessed slides (511) (522) of both upper and lower sections (51) and (52) of the joint (5). Accordingly, the lower section of the stem (4) is restricted from turning relatively to the pivoted inner tube (2) to facilitate its sliding movement for either extending or retreating. In addition, both of the upper part (51) and the lower part (52) of the joint are made standing upright and held in position with the steel ball (542) from the tenon (54) inserted in the slit (513), and then pressed into and concealed in the pivoted inner tube (2). Meanwhile the fixing bolt (33) from the retainer (3) is inserted into the slide (512) of the upper end (51) to further hold both parts of the joint (5) in position. The fast wrench (31) from the retainer (3) is used to tightly fasten and lock up the pivoted inner tube (3) relatively to the lower section of the stem (4), thus forming a pivoting structure concealed in the pivoted inner tube (2) of the head tube.

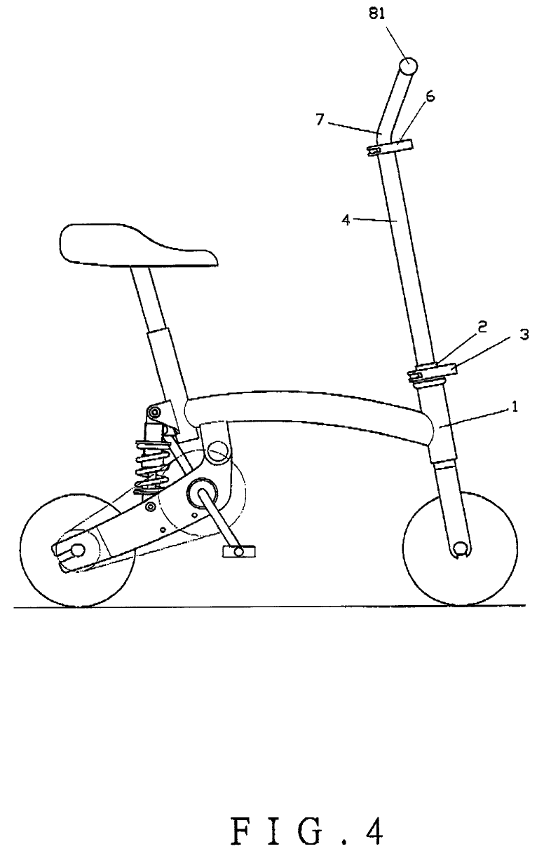

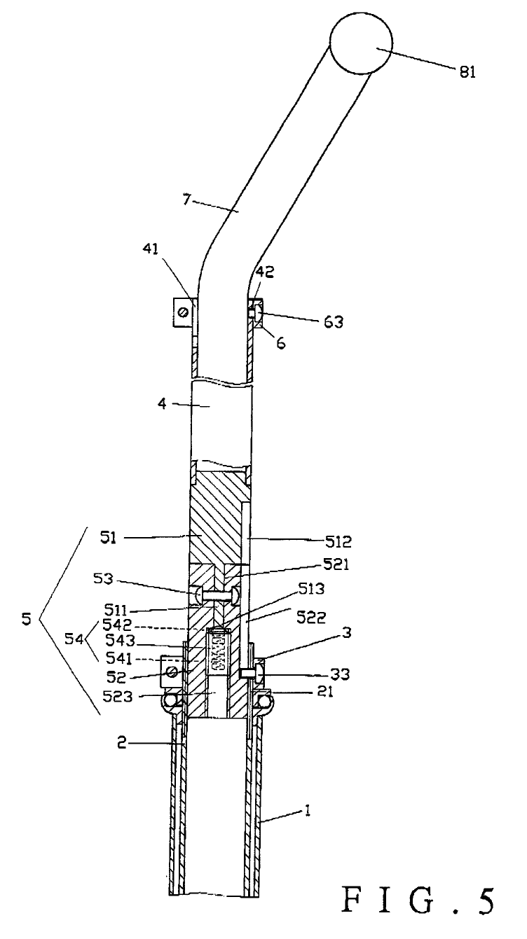

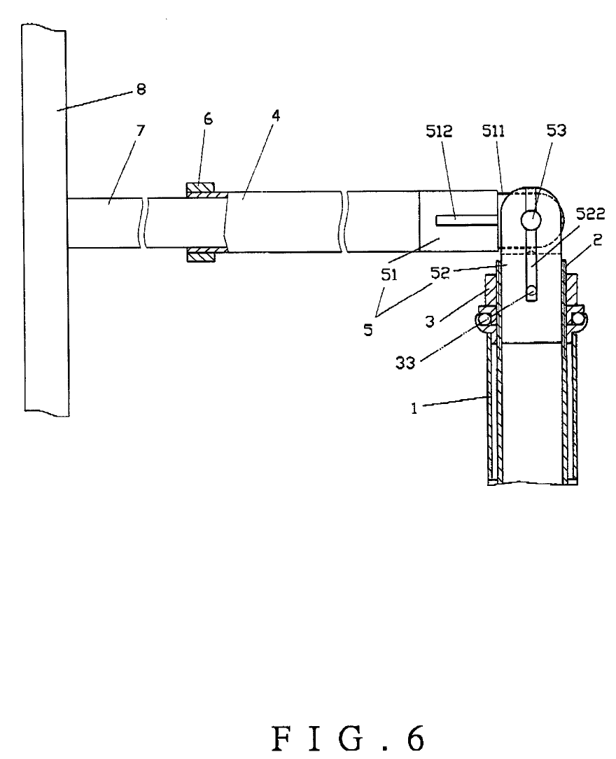

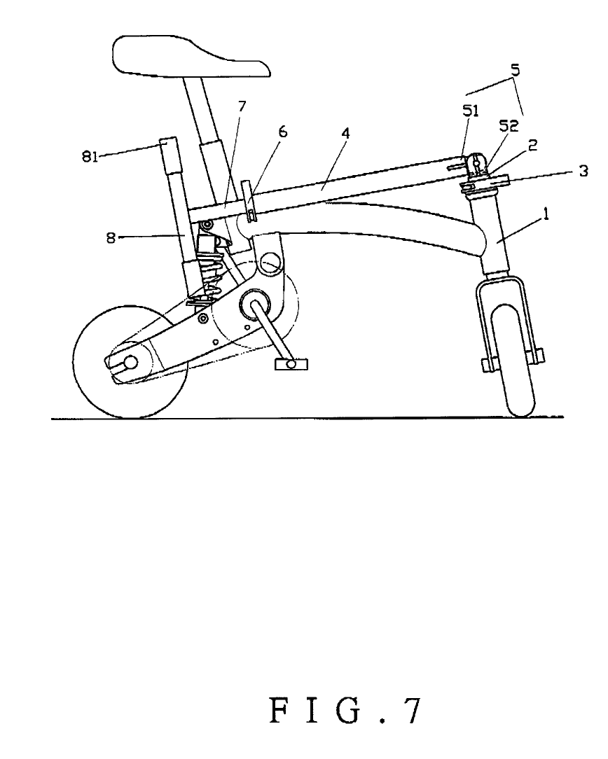

Upon folding up the handle as illustrated in FIG. 4, release the fast wrench (61) from the retainer (6) at the upper end of the lower section of the stem (4). The upper section of the stem (7) inserted inside the lower section of the stem (4) retreats into the stem for a length reduction while the handle (81) can be put at a comfortable height for a rider of the bike by proper adjustment of the length. Furthermore, the fast wrench (31) on the pivoted inner tube (2) is released to free the retainer (3) from restricting the pivoted inner tube (2), thus to release the joint (5) on the lower end of the lower section of the stem (4). As illustrated in FIG. 5, the lower section of the stem (4) is capable of pulling up the joint (5) to expose certain portion of the upper part (51) of the joint (5) from the upper end of the pivoted inner tube (2). Referring to FIG. 6, (when both of the handle and the pivoted inner tube (2) are turned sideways), the lower section of the stem (4), the upper section of the stem (7) and the substantial part of the body (8) of the handle (81) can be folded up and lying against the center of the frame as illustrated in FIG. 7 to achieve a compact volume of the bike for easy storage and carriage. Once the lower section of the stem (4) extends to its extreme, the fixing bolt (33) of the retainer (3) will hold against the end of the slide (522) in the lower part (52) of the joint (5) to prevent the lower section of the stem (4) from being pulled out to leave the bike.

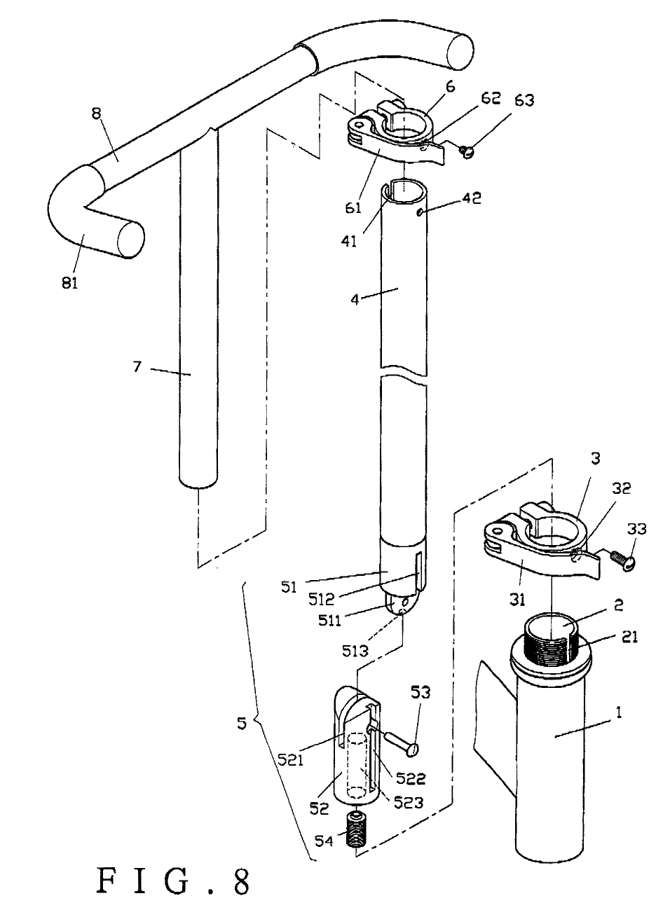

Furthermore, the body (8) of the handle (81) and the handle (81) connected to the upper section of the stem (7) can be varied as illustrated in FIG. 8. Wherein, the extended upper part of the upper section of the stem (7) curved forwardly and upwardly can be changed to a straight section with its upper end connected in position to the lateral section of the body (8) of the handle (81). Both ends of the lateral section are curved forwardly to form a shorter section slightly warping upward for providing pair of horn like handles (82).

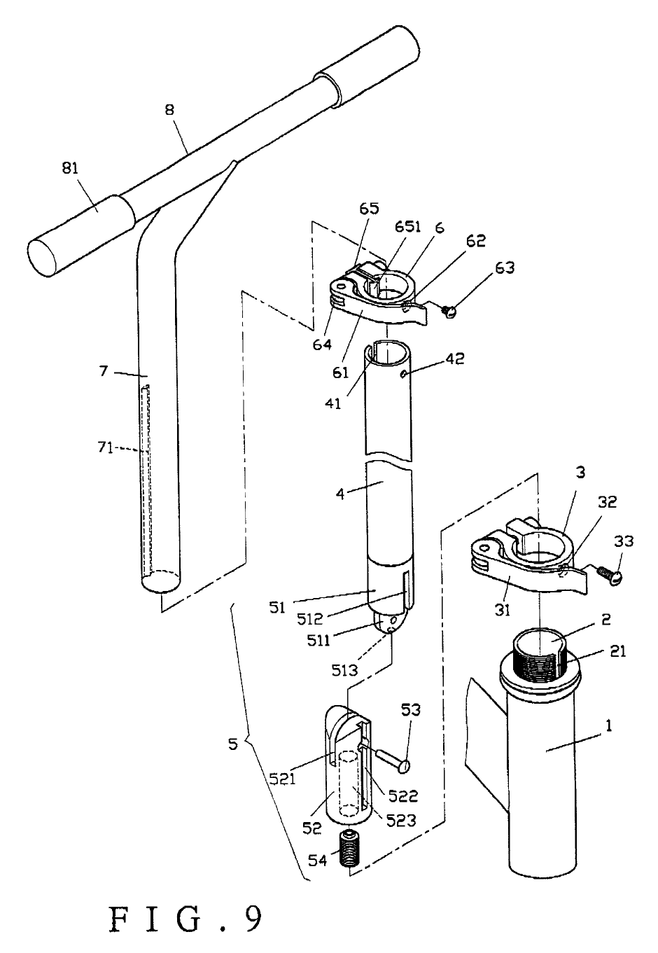

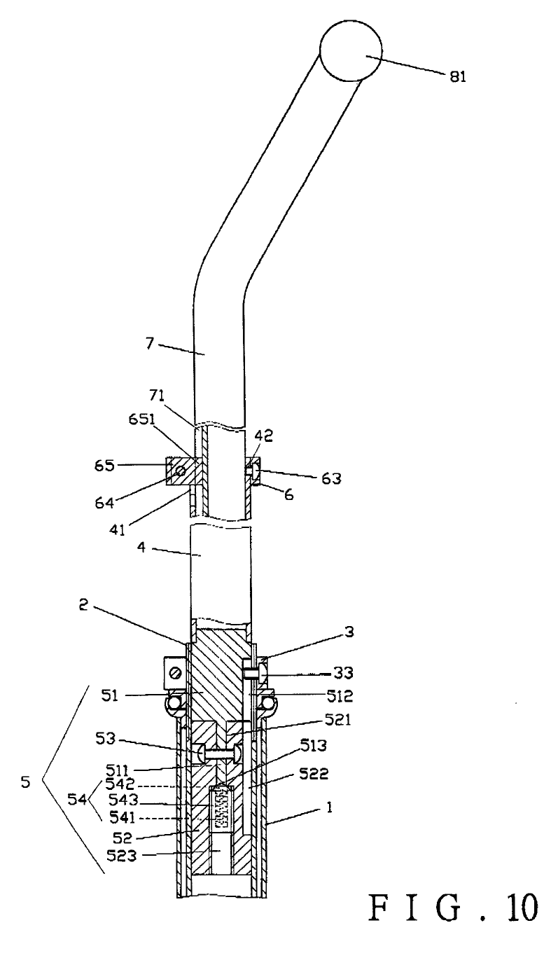

A mechanism to restrict the upper section of the stem (7) from revolving may be designed in the planning of the extension by the upper section of the stem (7) in relation to the lower section of the stem (4) to achieve an oriented extension longitudinally by the upper section of the stem (7) as illustrated in FIGS. 9 and 10. Wherein, a fixing member (65) may be inserted through a pivoted pin shaft (64) between open ends of the ring of the fast wrench (61) from the retainer (6) on the lower section of the stem (4). A tapered stopper (651) is formed at the end of the inner side of the slit (41) in the lower section of the stem (4) while a longitudinal slide (71) is formed on the upper section of the stem (7) at where corresponding to the tapered stopper (651) at the fixing member (65). As a result, the upper section of the stem (7) is restricted from turning without compromising its smooth operation of extension since the slide (71) and the tapered stopper (651) are holding against each other.

I claim:

1. A folding mechanism for a mini bike comprised of a head tube, a pivoted inner tube, two retainers, a lower section of a stem, a joint, an upper section of the stem, and a body of a handle with the stem extending by section and folded up for storage in relation to the head tube, characterized by:
a section protruding from the pivoted inner tube inside the head tube having a slit provided axially in the wall of said extended section and inserted with a retainer having a fast wrench, and the fast wrench having on its ring a fixing bolt extending in the slit inside the pivoted inner tube;
the stem divided into an upper section and a lower section with the latter inserted into the pivoted inner tube, a joint provided on the end of the insertion accommodated inside the pivoted inner tube, the joint has an upper part and a lower part pivoted to each other, a longitudinal slide formed on each of the side of both parts of the joint in the direction corresponding to that of the slit inside the pivoted inner tube, the fixing bolt of the retainer extending and holding against the slide, a certain portion of the lower part of the joint extends into the pivoted inner tube and held in position in normal condition, a tenon and recess provided at a relative inner end of either of upper or of the lower part of the joint, another retainer having another fast wrench inserted to the upper end of the lower section of the stem, the upper section of the stem inserted to the lower section of the stem via said another retainer, and the upper section of the stem having its upper part curved fowardly and upwardly to connect in position to a lateral section from the body of the handle.

2. A folding mechanism for a mini bike as claimed in claim 1, wherein, both of said upper and lower parts of the joint are inserted to each other with a protruding panel and a pivot connected through with a rivet while either of the upper part or the lower part having its relative inner end to form a hole for accommodating a tenon comprised of a coil holding against a steel ball contained in a chamber, and a recess provided on the protruding plate of the upper part of the joint at where corresponding to the steel ball of the tenon.

3. A folding mechanism for a mini bike as claimed in claim 1, wherein, a slit together with a hole is respectively and axially provided on both symmetrical sides of the upper end of the lower section of the stem, and a threaded hole is provided relatively to the inserted retainer for coupling a fixing bolt.

4. A folding mechanism for a mini bike as claimed in claim 1, wherein, the upper section of the stem is made a straight section and fixed to a lateral section of the body of the handle, with both ends of the lateral section curved forwardly to form a pair of shorter length and warping slightly upward handles.

5. A folding mechanism for a mini bike as claimed in claim 1, wherein, a fixing member is inserted through a pin shaft pivoted to the retainer on the upper section of the stem at where between open ends of the ring of the fast wrench used for the lower section of the stem to pass through, said fixing member having a tapered stopper formed at its inner end facing the slit in the lower section of the stem, and a longitudinal slide formed on the upper section of the stem at where corresponding to said tapered stopper.
